(19) United States
(12) Patent Application Publication
(10) Pub. No.: US 2008/0263126 A1
(43) Pub. Date: Oct. 23, 2008

(54) INTERNET BRIDGE FOR APPLICATIONS AND WEB SERVERS

(75) Inventor: ANAND KESHAV SOMAN, Pune (IN)

Correspondence Address: ANAND KESHAV SOMAN, A-32 ABHIMANSHREE SOCIETY, PASHAN ROAD, PUNE, MH, 411008, IN

(73) Assignee: Nirali Sanghi, Pleasanton, CA (US)

(21) Appl. No.: 12/041,678

(22) Filed: Mar. 4, 2008

Related U.S. Application Data
(60) Provisional application No. 60/923,973, filed on Apr. 18, 2007.

(51) Int. Cl. G06F 15/16; G06F 15/177

(52) U.S. Cl. 709/201; 709/222

(57) ABSTRACT

The disclosure describes a method for enabling internet access to resource hosted on CSDs without a real or static IP by creating a global URL and a local pathway for a locally accessible CSDs hosted resource using an internet bridge program residing on a CSD. A master server registers the CSD by assigning a unique CSD ID and credentials, a database residing on the master server registers all the details of the CSDs. The CSD initiates a communication with the master server over internet. A requesting computer forwards the global URL to the master server, which in turn forwards the global URL to the CSD. The CSD forwards the requested data to the master server. The master server forwards the requested data to the requesting computer using the internet browser.

### CROSS-REFERENCE TO RELATED APPLICATIONS

This application claims priority to and incorporates by reference provisional application No. U.S. 60/923,973 filed on Apr. 18, 2007.

### FEDERALLY SPONSORED RESEARCH OR DEVELOPMENT

Not applicable

### PARTIES TO A JOINT RESEARCH AGREEMENT

Not applicable

### REFERENCE TO A SEQUENCE LISTING, A TABLE, OR A COMPUTER LISTING

Not applicable

### FIELD OF THE INVENTION

This invention relates to computers, digital data processing systems, or corresponding data processing method including apparatus or steps for transferring data or instruction information between a pluralities of computers.

### BACKGROUND OF THE INVENTION

Conventionally, web servers are computers that host web sites and web services and are accessible by other computers using common protocols such as HTTP, FTP, etc. Web servers are high-end machines, running web-server software such as Microsoft Corporation's IIS, Apache Software Foundation's Apache Web server, etc.

Web servers require a real, static internet protocol address that can be used by other computers on the internet to reach them. However, in case of most personal computers, IP address changes dynamically every time the computers reconnect to the internet. If the personal computer is behind a router or a firewall that does Network Address Translation (NAT), the computer may not have a “real” IP address at all. Thus, it becomes difficult for personal computers to host web servers. Personal computers are not used for hosting web sites or web services due to security considerations also.

### OBJECTS OF INVENTION

An object of the invention is to allow users to directly host web sites/web services on personal computers, even though the personal computer may not possess a static or “real” IP address.

Another object is to enable a web server to continue to work transparently when the IP address of the machine changes dynamically.

Yet another object is to enable a personal computer (PC) to function as a web server even if the PC is behind routers/firewalls that perform network address translation.

### SUMMARY OF INVENTION

Usually, the IP address of a computer changes dynamically every time the computer reconnects to the internet. The disclosure describes a method for enabling internet access to resources hosted on a computer (e.g. a desktop computer, a laptop computer, a PDA, a server, etc.) or a storage device (e.g. a hard derive, a flash memory, a pen drive, etc.) not having a real or static IP address. In an embodiment of the invention, the method comprises a number of steps that are listed in the following paragraphs.

One-step is to create a global URL and a local pathway for a resource hosted on a locally accessible computer or storage device (“CSD”) that does not have a static and real IP address is. The global URL may be built by combining a CSD ID, a resource ID, and the domain name of a master server. The global URL and the local pathway of the resource may be stored in a registry file on the CSD. The hosted resource may be a website, a web service or, an application. This step may be implemented by using an internet bridge program residing on the CSD or another computer connected to the CSD through a local area network (LAN).

In another step, a master server registers the CSD by assigning a unique CSD ID and credentials to the CSD. The credentials may be a secure password known to the CSD and the handshake server application. Alternatively, the credentials may be a public-private key pair assigned to the CSD and the public key of the handshake server application. All the registration information about the registered CSDs is usually maintained in a database accessible to the master server.

In another step, the CSD establishes a secure communication with the mater server by initiating a handshake protocol with the master server and using the CSD ID and the credentials. As soon as the communication channel is established, the CSD is marked as active CSD in the CSD database.

In another step, a user wishing to access the resource hosted on the CSD uses an internet browser on a computer (also called a requesting computer) to enter the global URL of the resource; the request first reaches the master server.

In another step, the master server forwards the global URL to the corresponding CSD. The CSD accesses the resource and returns the requested information to the master server. The server forwards the requested information to the requesting computer.

In another embodiment, the master server has access to a standard web server application and a handshake server application. Both the handshake server application and the standard web server application are accessible over the internet. A CSD registration database is accessible to both the standard web server and the handshake server. The registration of the CSD on the master server is done by the handshake server application.

In another embodiment, the internet bridge program builds a list of images and other embedded links in a web page the first time a web page is requested from the hosted web site. The internet bridge program sends the embedded links simultaneously with the web page to the master server when the page is requested subsequently.

In yet another embodiment, the internet bridge program has a user interface that enables a publisher (a person) to identify the specific resources that he or she wants to publish.

In another embodiment, the global URL is mapped to a domain name in the master server, enabling the internet browser of the requesting computer to access the master server using the domain name instead of the global URL.

### BRIEF DESCRIPTION OF THE DRAWINGS

FIG. 1 shows block diagram of an embodiment of the invention disclosed herein.

FIG. 2 shows a flow diagram of the overall process of an embodiment.

FIG. 3 shows, in an embodiment, the communication channels between CSDs and a master server.

FIG. 4A illustrates an embodiment in which both the internet bridge program and the published resource reside on the same CSD.

FIG. 4B illustrates an embodiment in which the internet bridge program and the published resource reside on different CSDs connected to each other through a local area network.

FIG. 5 shows, in an embodiment, a user interface used by a publisher to host and un-host resources.

### DETAILED DESCRIPTION OF THE PREFERRED EMBODIMENTS

In the following description of various embodiments including the preferred embodiments, reference is made to the accompanying drawings, which show by way of illustration some of the embodiments in which the invention may be practiced. It is to be understood that other embodiments may be used and structural and functional modifications may be made without departing from the spirit or scope of the invention. Those skilled in the art will readily appreciate that the detailed description given herein with respect to these drawings is for explanatory purposes as the invention extends beyond these limited embodiments.

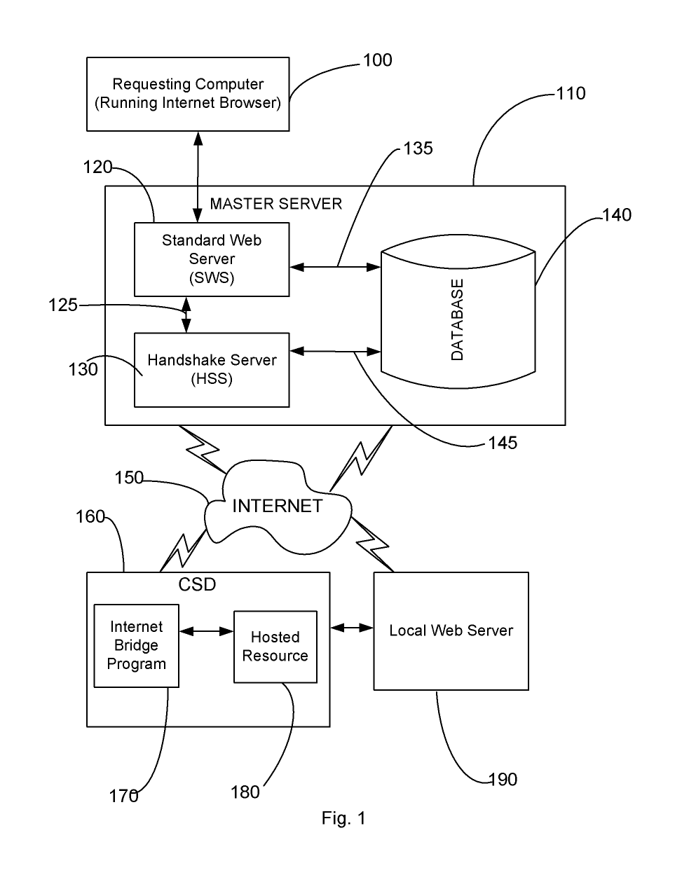

FIG. 1 shows a block diagram of an embodiment of the invention disclosed herein. The invention discloses a requesting computer 100 that may be connected to a master server 110 through an internet. A computing and/or storage device (hereinafter called CSD) 160 may also be connected to the master server 110 through the internet 150. Examples of computing and/or storage device 160 can be computer servers, mainframe computers, personal computers, laptops, handheld computers, storage devices, smart drives including pen drives, etc.

The CSD 160 may include an internet bridge program 170 and a hosted resource 180. The CSD 160 can be connected to a local web server 190. (In other embodiments described later, the internet bridge program and hosted resource may reside on different CSDs connected to each other over a local area network). The CSD 160 may establish a connection with the local web server 190 to publish (to make it web-accessible), the hosted resource 180. Examples of the hosted resource can be web sites/web services and/or applications hosted on it. A publisher (a person) may identify the hosted resource 180 and communicates it to the CSD 160. The CSD 160 can make HTTP requests to the local web server 190 and receive the data returned by the local web server 190 in response.

The master server 110 may comprises of multiple components such as a standard web server 120, a handshake server 130, and a database 140. The standard web server 120 performs the standard web server functionality. Examples of standard web server are Microsoft's IIS, Apache Software Foundation's Apache, etc. The database 140 performs normal database operations and stores records. The database 140 can be used to store records and information and can be accessible to both the standard web server 120 and the handshake server 140 through communication channels 135 and 145. Additionally the handshake server 120 and the standard web server 130 can communicate with each other using a communication channel 125. The two server components of the master server 110, i.e. the standard web server 120 and the handshake server 130, can be accessed by any other CSD connected to the internet using the publicized internet protocol address of the master server 110, which can be “real” and “static”.

In different embodiments, the standard web server 120 and the handshake server 130 may have different IP addresses. The CSD 160 wishing to make resources web accessible may have to first register with the handshake server 130. The process of registration may involve allocation of a unique username to the CSD 160 by the handshake server 130 and assigning of “credentials” that can be used by the CSD 160 to identify itself to the handshake server 130 over the internet. Once the CSD 160 gets registered with the handshake server 130, it can be marked as “Active CSD” in the database 140.

For every resource (web site/web service/application, etc.) identified by the publisher for publishing (being made web-accessible), the CSD 160 may use the internet bridge program 180 to generate an “access tag”. The access tag is a unique identifier for every resource that is made web-accessible from the CSD 160. The internet bridge program 180 ensures that the same access tag has not been allotted to any other resource in the CSD 160. In case the published resource is a web site/web service, the access tag can be a combination of the local web server name, port number and directory. The internet bridge program 180 also creates a global “unique resource locator” (hereinafter URL). The global URL can be used to access the published resource.

The global URL may be communicated publicly. The hosted resource may be accessed over the internet by entering the global URL into a standard internet browser on the requesting computer 100. The requesting computer 100 forwards the global URL to the master server 110 for retrieval of information. The master server 110 after receiving the global URL checks if the corresponding CSD 160 is marked as active in the CSD database. The master server 110 passes the global URL to the CSD 160. The CSD 160 after receiving the requested data from the published resource corresponding to the global URL forwards the requested data to the master server 110. The master sever 110 forwards the requested information to the internet browser of the requesting computer 100.

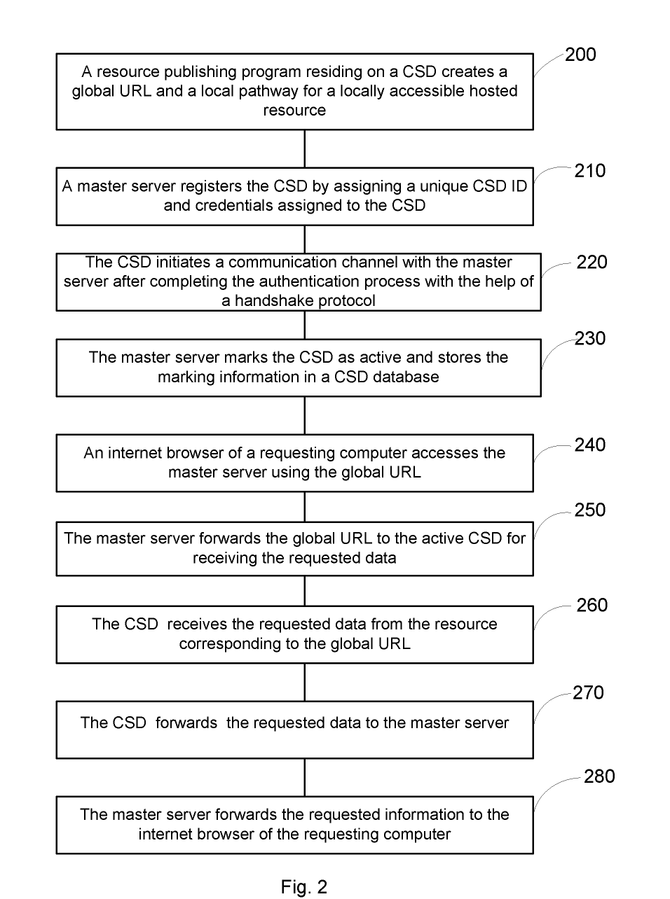

FIG. 2 shows a flow diagram of an embodiment.

In step 200, a publisher (a person) may identify a resource residing on a CSD for publication. An internet bridge program residing on the CSD (or another CSD connected to the first CSD through a local area network) creates a global URL and a local pathway for the locally accessible hosted resource.

In step 210, a master server registers the CSD by assigning a unique CSD ID and credentials to the CSD. The credentials may be a secret password known to the specific CSD and the handshake server. The credentials may also be a public-private key pair assigned to the CSD along with the public key of the handshake server.

In step 220, the CSD initiates, establishes, and maintains a communication channel with the master server using the internet. After initiation of the communication channel, the master server authenticates the CSD based on the CSD ID and the credentials assigned to the CSD.

In step 230, the master server marks the CSD as active and stores the marking information in a CSD database.

In step 240, when a recipient wants to access the resource, the recipient enters the global URL into any standard internet browser on his or her computer. Since the first part of the URL is the IP Address/Domain name of the master server, the internet browser directs the request to the master server.

In step 250, the server receives the URL and parses the username from the URL, and then looks it up in its CSD Database to determine if the CSD is presently active. If it is, the server forwards the URL to the CSD, over the communication channel with the CSD. If the CSD is not presently active in the CSD database, or if the URL is not present in the registry field of the specific CSD, a message is returned to the recipient's computer stating invalidity of the URL.

In step 260, the CSD looks up its registry to determine if a resource corresponding to such a URL has been hosted from the CSD.

In step 270, if such a URL entry exists in the registry file, the CSD returns that file to the master server.

In step 280, the master server forwards the file to the recipient's computer.

The operations described above ensure that the files on the CSD can be accessed from the recipient's internet browser via the master server, as long as the CSD can access the Internet. In this manner, the CSD, which could be any computer, laptop, handheld, or even a smart storage device, can be made to provide the common functionality of a web server, i.e., sharing files.

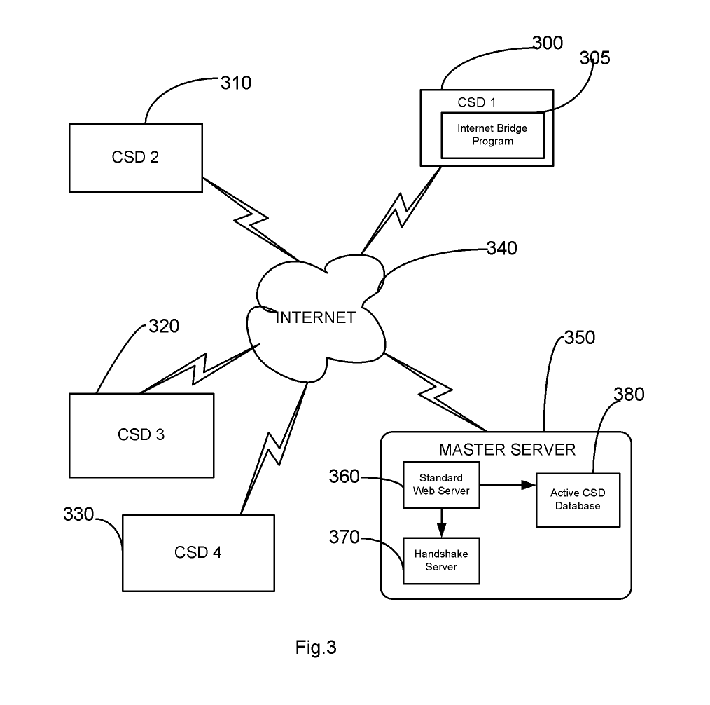

FIG. 3 discloses another embodiment. The embodiment shows CSDs 300, 310, 320, and 330 connected to a master server 350 using internet 340. The CSD 300 includes an internet bridge program 305. The master server 350 includes a standard web server 360, a handshake server 370, and a database 380.

The internet bridge program 305 may be used to host a variety of resources, for example, web site, web service, application, etc. If a publisher wants to publish any resource, he/she can identify the resource residing on a CSD. The internet bridge program 305 residing on the CSD 300 generates a global URL for identification of the resource. The ‘global URL’ may be used to access the identified resource from any computer connected to the internet via a browser.

In some embodiments, the global URL may be generated by combining a username, an access tag (which itself may combine the local web server name, port no. and directory) and the domain name of the master server 350 in a manner that ensures that the global URL has syntactically valid characters and format.

For example, a global URL may be constructed in the format:

http://Username-LocalWebServer-PortNo.MasterServerDomainName/Directory

In some embodiments of the invention, the resource that is hosted on the CSD 300 may be a web site/web service. The web site/web service has by default a ‘local URL’ as well, which is the URL that would be used to access the web site/web service from the CSD 300 by the publisher using the HTTP protocol. For example, the local URL may be of the form http://LocalWebServer:PortNo/Directory. The internet bridge program 305 may store the local URL of the resource, and its corresponding global URL, and an entry indicating that this is a web site/web service in a record file, called the ‘Registry’.

In some embodiments of the invention, the resource that is hosted on the CSD 300 may be an application or software or an executable program. In such cases, the access tag can simply be the full path (including name) of the application relative to the local area network, which automatically ensures its uniqueness.

The internet bridge program 305 stores the full path name of the application, its corresponding global URL, and an entry indicating that this is an application in the Registry.

The ‘Registry’ for the CSD 300 contains a mapping of all the local URLs to the global URLs in case of web sites/web services and application file paths to the global URLs for applications hosted from the CSD 300.

The internet bridge program 305 also allows the user to ‘un-host’ a previously hosted resource, in which case the information corresponding to the resource can be deleted from the registry.

The hosted resource can be accessed over the internet by entering the global URL into an internet browser of a requesting computer (not shown) by a user.

At the time the global URL is entered into the browser of the requesting computer, the CSD 300 should be connected to the internet, and its internet bridge program 305 should be running. The CSD 300 may have changed its IP address since the time the resource was hosted for a number of reasons, for example in the interim it may have been powered off and on, or allocated a different dynamic IP address, or moved physically to a different location where a different provider provides Internet services.

Anytime the CSD 300 is reconnected to the Internet or undergoes a change of IP address for whatever reason or when the internet bridge program 305 is restarted, the internet bridge program 305 undertakes a handshake protocol with the handshake server 370 as follows:

The internet bridge program 305 establishes a communication connection (often called a ‘socket’ in technical parlance) with the handshake server 370 (using the IP address and the port of the handshake server 370) and maintains this connection ‘alive’, i.e. does not close it until the CSD 300 is closed. Such a connection is also termed a ‘persistent connection’ or a ‘persistent socket’, since it stays active all the time, and can be used for two-way communication, i.e. from the CSD 300 to the handshake server 370 and vice versa. This is possible even for CSDs that are behind NAT routers, proxies, firewalls, etc., because the connection is being initiated and made by the CSD with the handshake server, rather than the other way around. The CSD authentically identifies itself to the handshake server, using its credentials, using a predefined protocol.

Two examples of handshake protocol are described below.

Handshake Protocol 1:

When the credentials of the CSD comprise only a secret password, the CSD communicates to the server its username and a pre-designated code encrypted with the secret password. The server decrypts it with the same secret password (which it already has in its CSD database), verifies the correctness of the pre-designated code and sends back to the CSD a ‘session key’ also encrypted with the secret password. The session key can thereafter be used to encrypt further communication between the server and the CSD in this session, i.e., until the handshake protocol is re-executed between the CSD and the server.

Handshake Protocol 2:

When the credentials of the CSD comprise its public-private key pair and the public key of the server, the following protocol can be used. The CSD first sends the server a ‘Handshake Signal’ which involves sending to the server the Username of the CSD along with a ‘certificate’ that establishes the identity of the CSD with the server. One example of such a certificate is to compose the certificate of: (i) a number randomly generated by the CSD (called ‘Random Number—A’), together with (ii) the same random number (‘Random Number—A’) ‘signed’ by the private key assigned to the CSD at the time of its registration. The username along with this certificate is further encrypted with the public key of the server to ensure that only the server can read the handshake signal contents. The server upon receipt of this handshake signal, decrypts its contents with its own private key to obtain the username of the CSD, and then looks up the public key corresponding to the username stored in its CSD Database. This is used to verify that the signed random number within the certificate after authentication with the CSD public key matches with the plainly stated random number ‘Random Number—A’ in the certificate. If this verification is successful, the identity of the CSD is established and the server sends a ‘Handshake Acknowledgement’ to the CSD. This Handshake Acknowledgement comprises a session Key, the random number sent by the CSD as a part of the handshake (‘Random Number—A’) and a server certificate, all together encrypted with the public key of the CSD. The server certificate itself is created with two parts (i) a number randomly generated by the server (‘Random Number—B’) together with (ii) the same randomly generated number (‘Random Number—B’) ‘signed’ by the private key of the server. Upon the receipt of the handshake acknowledgement, the CSD Program decrypts it using its own private Key. It verifies that the random number being returned by the server (‘Random Number—A’) is same as the random number it had sent to the Server as a part of the Handshake Signal. It stores the session key sent by the server for further use and also verifies the server certificate. This process of verification of the server certificate involves ensuring that the signed random number after authentication with the server public key matches with the plain random number (‘Random Number—B’) presents in the server certificate. The session key can be used to encrypt further communication between the server and the CSD in this session, i.e., until the Handshake Protocol is re-executed between the CSD and the Server. Finally, to close the Handshake Protocol, the CSD sends to the server a ‘Connection Continue’ signal, comprising its username, and the ‘Random Number—B’ encrypted with the session key. The receipt of this ‘Connection Continue’ signal is an indication to the server that the CSD is authentic and that the files stored on it are now ready to be accessed using their URLs. The server therefore marks this CSD as ‘active’ in its CSD Database. If either the certificate sent by the CSD cannot be authenticated by the server or the certificate sent by server cannot be authenticated by the CSD, or if the random number in the Connection Continue signal received by the Server does not match ‘Random Number—B’ the connection is not established.

Normally, a disconnection of a CSD from the Internet (or termination of the CSD Program) is detected by the server from the breakage of the communication channel established by the CSD between itself and the server. Such a detection of disconnection forces the server to mark that CSD as ‘inactive’ in its CSD Database. Therefore, the server at any given time has information of all the CSDs accessible over the Internet along with their communication channels with itself. In most common manifestation, the communication channel over the Internet is a ‘Socket’ established by the CSD with the server. When a CSD is active, i.e., has a communication connection established with the server, the CSD Program is able to receive and process any messages from the server.

Because all communication between the CSD and the server is over such a channel (socket) established by the CSD, the server does not need to establish a connection with the CSD on its own. Therefore, the CSD may change its IP Address or not even have a static or ‘real’ IP Address. All it needs to do is to initiate and perform the Handshake Protocol after establishing a communication channel (socket) to the server whenever it connects to the Internet.

The public and private keys denote the keys of a public-key algorithm such as the Rivest Shamir Adelman (RSA) algorithm. The username, the credentials and the IP Address/Domain name of the handshake server 370 can be stored on the CSD 300 at the time of registration. For every CSD registered, the handshake server 370 maintains a record of the CSD username and the CSD credentials in the database 380 called the ‘CSD Credential Database’.

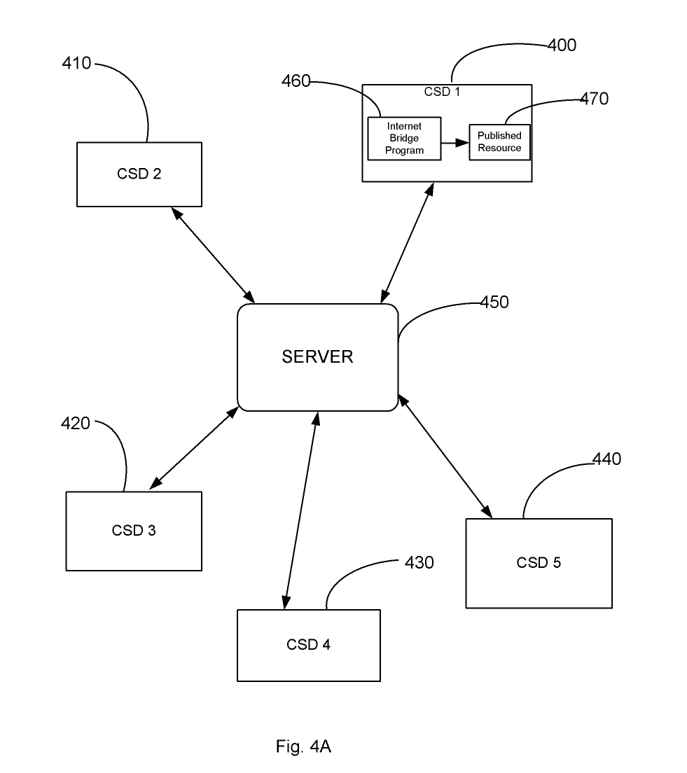

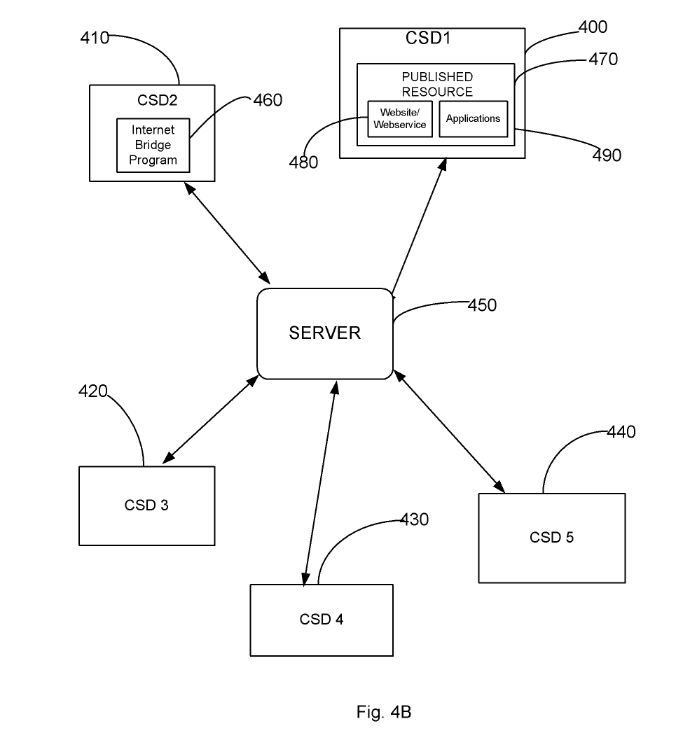

FIG. 4(a) and FIG. 4(b) show different embodiments. Both FIG. 4(a) and FIG. 4(b) show a local area network comprising a number of CSDs 400, 410, 420, 430, 440 etc. connected to a server 450.

FIG. 4(a) shows an embodiment in which the CSD 400 hosts both an internet bridge program 460 and a published resource 470.

The FIG. 4(b) shows another embodiment in which the internet bridge program 460 and the published resource 470 may reside on different CSDs, provided both the CSDs are connected to each other over a local area network. For example, in the embodiment shown in FIG. 4(b), the internet bridge program 460 resides on CSD 410 and the published resource 470 resides on the CSD 400. The published resource 470 may be further a website/web service 480 or an application 490.

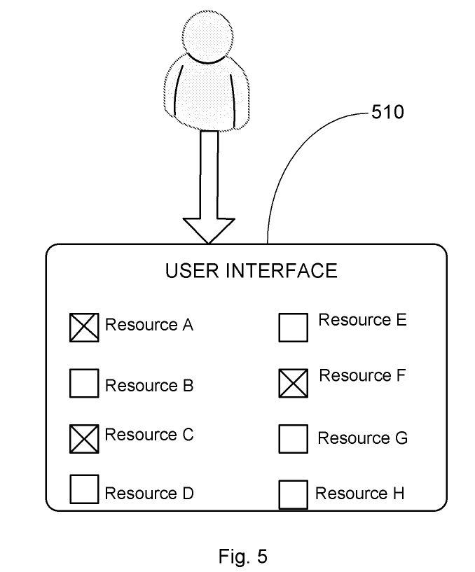

FIG. 5 shows another embodiment in which a publisher (a person) may use a user interface 510 for selecting or deselecting the resources to be hosted or un-hosted from a CSD. For example, the user interface 510 shows a set of resources A-H to the publisher. By checking or un-checking the displayed resources, the publisher may conveniently indicate at any time the resources that he or she desires to host and the resources that he or she may un-host.

Having fully described the preferred embodiments, other equivalent or alternative methods of enabling internet access to information hosted on a CSD according to the present invention will be apparent to those skilled in the art. The invention has been described above by way of illustration, and the specific embodiment disclosed is not intended to limit the invention to the particular forms disclosed. For example, the embodiments described in the foregoing were directed to providing clear ideas about the preferred modes, including the best mode, of making and using the present invention; however, in alternate embodiments, those skilled in the art may implement the invention using various other means without deviating from the central idea of the invention. The invention therefore covers all modifications, equivalents, and alternatives falling within the spirit and scope of the following claims.

We claim:

1. A method for enabling internet access to resources hosted on CSDs without a real or static IP address, the method comprising:
creating a global URL and a local pathway for a locally accessible hosted resource using an internet bridge program residing on a CSD not having a static or real IP address, but the CSD having internet access to a master server having a real and static IP address and the global URL being a syntactically valid HTTP request pointing to the master server and incorporating information about both the CSD and the hosted resource;
the master server registering the CSD by assigning to the CSD a unique CSD ID and credentials to authenticate itself to the master server, registration information about all registered CSDs being maintained in a database accessible to the master server;
the CSD initiating, establishing, and maintaining a communication channel with the master server over the internet and authenticating itself by initiating a handshake protocol with the master server using the CSD ID and the credentials;
marking the CSD which has established a communication channel with the master server as an active CSD in an Active CSD Database;
an internet browser of a requesting computer accessing the master server using the global URL;
if the CSD is currently marked active in the Active CSD Database, the master server forwarding the global URL to the corresponding CSD;
the CSD receiving the requested data from the resource corresponding to the global URL;
the CSD forwarding the requested data to the master server; and
the master server forwarding the requested information to the internet browser of the requesting computer.

2. The method of claim 1 wherein:
the master server has access to a standard web server application and a handshake server application, the standard web server application and the handshake server application both accessible to other computers having internet access, and the database accessible to both the standard web server application and the handshake server application; and
the registration of the CSD on the master server is done by the handshake server application.

3. The method of claim 1 wherein the published resource is hosted on the CSD itself.

4. The method of claim 1 wherein the published resource is hosted on another CSD connected to the CSD through a local area network.

5. The method of claim 1 wherein the published resource is a web site or a web service; the local pathway is a local URL; and the global URL and the local URL are stored in a registry file on the CSD.

6. The method of claim 5 wherein the internet bridge program builds a list of images and other embedded links in a web page the first time the web page is requested from the hosted web site and sends data corresponding to the embedded links simultaneously with the web page to the master server when the page is requested subsequently, to speed up the rendering of the entire web page on the requesting computer.

7. The method of claim 1, wherein the published resource is an application; the local pathway is the full file path of the local application, and the global URL and the local pathway are stored in a registry file on the CSD.

8. The method of claim 1 wherein the credentials comprise a secure password known to the CSD and the handshake server application.

9. The method of claim 1 wherein the credentials are a public-private key pair assigned to the CSD and the public key of the handshake server application.

10. The method of claim 1 wherein the internet bridge program:
has a user interface that enables a publisher to identify specific resources to be published;
generates a resource ID for each resource identified for publishing; and
generates the syntactically valid global URL by combining the CSD ID, the resource ID, and the domain name of the master server.

11. The method of claim 1, wherein the CSD is a computing device.

12. The method of claim 1 wherein the CSD is a storage device attached to a computing device.

13. The method of claim 1 wherein the global URL is mapped to a domain name in the master server, and the domain name is pointed to the Internet Protocol Address of the master server, enabling the internet browser of the requesting computer to access the master server using the domain name and to replace the global URL with the domain name.

14. A system for enabling internet access to resources hosted on CSDs without a real and static IP address, the system comprising:
a CSD not having a static or real IP address, but having access to an internet;
a master server having a real and static IP address with the global URL pointing to the master server, the CSD having internet access to the master server and the master server registering the CSD by assigning to the CSD a unique CSD ID and credentials to authenticate itself to the master server;
an internet bridge program residing on the CSD for creating a global URL and a local pathway for a locally accessible hosted resource, the global URL being a syntactically valid HTTP request pointing to the master server and incorporating information about both the CSD and the hosted resource;
a standard web server application and a handshake server application accessible by the master server; and
a database accessible to both the standard web server application and the handshake server application, registration information about all registered CSDs being maintained in the database.

15. The system of claim 14, wherein the published resource is hosted on the CSD itself.

16. The system of claim 14, wherein the published resource is hosted on another CSD connected to the CSD through a local area network.

17. The system of claim 14 wherein the published resource is a web site or a web service; the local pathway is a local URL; and the global URL and the local URL are stored in a registry file on the CSD.

18. The system of claim 14, wherein the published resource is an application; the local pathway is the full file path of the local application, and the global URL and the local pathway are stored in a registry file on the CSD.

19. The system of claim 14 wherein the resource publishing program:
has a user interface that enables a publisher to identify specific resources to be published;
generates a resource ID for each resource identified for publishing; and
generates the syntactically valid global URL by combining the CSD ID, the resource ID, and the domain name of the master server.

20. The system of claim 14 wherein the CSD is a computing device.

21. The system of claim 14 wherein the CSD is a storage device attached to a computing device.
